(19) United States
(12) Patent Application Publication
(10) Pub. No.: US 2012/0282437 A1
(43) Pub. Date: Nov. 8, 2012

(54) FILM FOR PHOTOVOLTAIC DEVICES

(75) Inventors: Sarah L. Clark, Somerville, MA (US); Nikhil N. Bhiwankar, Charlton, MA (US); Yu Zhong, Shrewsbury, MA (US); Vignesh Rajamani, Wilmington, MA (US); Gowri Dorairaju, Marlborough, MA (US); Christian C. Honeker, Acton, MA (US); Jean-Philippe Mulet, Ozoir-La-Ferriere (FR); Mathieu Berard, Paris (FR)

(73) Assignee: SAINT-GOBAIN PERFORMANCE PLASTICS CORPORATION, Aurora, OH (US)

(21) Appl. No.: 13/220,110

(22) Filed: Aug. 29, 2011

Related U.S. Application Data
(60) Provisional application No. 61/482,482, filed on May 4, 2011.

(51) Int. Cl. B32B 3/00; B32B 38/10

(52) U.S. Cl. 428/141; 156/247

(57) ABSTRACT

A textured film is provided. The textured film includes a first layer forming an outer surface and including a fluoropolymer. A second layer includes an encapsulant layer. The first layer and the second layer are mechanically textured to provide a plurality of surface features on the outer surface and extend into the second layer. The film can be applied as a textured film overlying an active component of a photovoltaic device.

### CROSS-REFERENCE TO RELATED APPLICATION(S)

The present application claims priority from U.S. Provisional Patent Application No. 61/482,482, filed May 4, 2011, entitled “A Film for Photovoltaic Devices,” naming inventors Sarah L. Clark, Nikhil Bhiwankar, Yu Zhong, Vignesh Rajamani, Gowri Dorairaju, Christian Honeker, Jean-Philippe Milet, and Mathieu Berard, which application is incorporated by reference herein in its entirety.

### FIELD OF THE DISCLOSURE

This disclosure, in general, relates to methods for forming a photovoltaic device and a textured film.

### BACKGROUND

With increasing concern over the environment and an increasing interest in alternative energy sources, industry is turning to photovoltaic devices for generating power. Photovoltaic devices conventionally include an active component that receives sunlight and converts the sunlight into electricity. However, conventional materials useful in making active components are susceptible to damage by exposure to the environment.

Conventional configurations of photovoltaic devices include protective barriers that overlie the active components of the photovoltaic devices. Attempts have been made to use glass and other transparent inorganic materials to form protective barriers. However, such materials are rigid and are susceptible to fracturing in response to impact. As such, rigid inorganic materials are not useful in newer flexible photovoltaic devices and have limitations when used in other photovoltaic devices that may be exposed to hail or other storm damage. In addition, attempts have been made to use polymeric materials that have more flexibility, but tend to have limited transparency resulting in, at best, at least a partial degradation in solar collection efficiency.

As such, an improved protective bather and photovoltaic device would be desirable.

### SUMMARY

In an embodiment, a method of forming a photovoltaic module is provided. The method includes providing an active component, providing an encapsulant layer disposed on the active component, providing a fluoropolymer layer on the encapsulant layer, laying a fabric on a surface of the fluoropolymer layer, wherein the fabric has a plurality of openings configured to provide a textured pattern on the fluoropolymer layer. The method further includes laminating the active component, encapsulant layer, fluoropolymer layer, and fabric, and removing the fabric from the fluoropolymer layer to provide a textured fluoropolymer layer disposed on the encapsulant layer, the textured fluoropolymer layer having a plurality of surface features that form an outer surface.

In another embodiment, a textured film is provided. The textured film includes a first layer forming an outer surface and including a fluoropolymer. The textured film includes a second layer that includes an encapsulant. The first layer and the second layer are mechanically textured to provide a plurality of surface features on the outer surface and extend into the second layer.

In an embodiment, a method of forming a photovoltaic module is provided. The method includes providing an encapsulant layer having a first surface and a second surface, providing a fluoropolymer layer disposed on the first surface, mechanically texturing the encapsulant layer and the fluoropolymer layer to provide a plurality of surface features that form an outer surface and a texture depth extending into the fluoropolymer layer and the encapsulant layer, and laminating the mechanically textured encapsulant layer and fluoropolymer layer to an active device, wherein a mean slope of at least about 20° of the surface features is retained post lamination.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary photovoltaic device.

FIG. 2 includes an illustration of an exemplary photovoltaic device.

FIG. 3 includes an illustration of a cross section of an exemplary textured film.

FIG. 4 includes an illustration of a plan view of a photovoltaic film.

FIG. 5 includes an illustration of two exemplary textured embossing plates.

FIG. 6 includes an illustration of an exemplary textured embossing plate.

FIG. 7 includes an illustration of a textured film on a photovoltaic module.

The use of the same reference symbols in different drawings indicates similar or identical items.

### DETAILED DESCRIPTION

In an exemplary embodiment, a textured film includes a protective layer forming an outer surface of the film and includes an encapsulant layer to be disposed closer to an active component of a photovoltaic device than the protective layer. In an example, the protective layer is formed of a fluoropolymer. The textured film can be attached to an active component of a photovoltaic device. For example, the textured layer forms an outer surface of the photovoltaic device and the encapsulant layer is in contact with a surface of the active component. In an embodiment, the plurality of surface features extends inward into the textured film. In particular, the plurality of surface features can displace a portion of the encapsulant layer so that the outer surface is formed of the protective layer and the thickness of the encapsulant layer varies to compensate for the indentation of the surface features.

In an embodiment, any reasonable surface features may be envisioned that have a three dimensional aspect. For instance, the plurality of surface features are pyramidal, circular, spherical, square, rectangular, polyhedral, triangular, truncated triangular, tetrahedral, the like, or combination thereof. The surface features can be prismatic rows or pyramidal structures. In an example, the surface features can be sinusoidal or semispherical. The surface features may be regularly or irregularly disposed to form the textured film. In an embodiment, the depth of the plurality of surface features can be negative surface features or positive surface features. Each surface feature of the plurality of surface features can have a cross-sectional width (w), defined as the maximum dimension parallel to an underside of the textured film. The cross-sectional width can be in a range of about 0.01 mm to about 5.0 mm, such as a range of about 0.02 mm to about 5.0 mm, or even a range of about 0.035 mm to about 3.0 mm. Further, a surface feature can have a depth (t′) orthogonal to the cross-sectional dimension in a range of about 0.2 mm to about 10.0 mm, such as a range of about 0.2 mm to about 5.0 mm, or even a range of about 0.5 mm to about 2.0 mm.

In a particular example, the plurality of surface features provides an outer surface having a mean slope, defined as the slope of the surface relative to planes parallel to an active component to which the film is attached or underside of the textured film averaged (mean) across the surface, of at least about 20°. For example, at a given point, the surface can have a slope (α, α′, α″) relative to an active component on which the textured film is disposed. The slopes (α, α′, α″) are averaged to determine a mean slope. In particular, the mean slope can be at least about 20°, such as at least about 25°, at least about 28°, at least about 30°, at least about 32°, at least about 36°, or even at least about 40°. Mean slope is determined by converting height map data into slope data. The slope map can be converted to a slope histogram and the mean slope determined from the slope histogram.

In an embodiment, a method of forming a photovoltaic device and texturing a film is included. The method includes providing an encapsulant layer having a first surface and a second surface. Any reasonable method of providing the encapsulant layer is envisioned and is typically dependent upon the material used for the encapsulant layer. For instance, encapsulant layers may be laminated, extruded, coated, and the like. Encapsulants are materials that help protect the photovoltaic device. Such materials include, for example natural or synthetic polymers including thermoplastics, polyethylene (including linear low density polyethylene, low density polyethylene, high density polyethylene, etc.), polypropylene, nylons (polyamides), EPDM, polyesters, polycarbonates, ethylene-propylene elastomer copolymers, copolymers of ethylene or propylene with acrylic or methacrylic acids, acrylates such as poly(octadecyl acrylate); methacrylates, ethylene-propylene copolymers, poly alpha olefin melt adhesives such as including, for example, ethylene vinyl acetate (EVA), ethylene butyl acrylate (EBA) ethylene methyl acrylate (EMA); ionomers such as Surlyn® (e.g., acid functionalized polyolefins generally neutralized as a metal salt), acid functionalized polyolefins, polyurethanes including, for example, thermoplastic polyurethane (TPU), olefin elastomers, olefinic block copolymers, thermoplastic silicones, polyvinyl butyral, fluoropolymers, such as a terpolymer of tetrafluoroethylene, hexafluoropropylene, and vinylidene fluoride; or any combination thereof. In a particular embodiment, the encapsulant layer is a cross-linkable polymer. In an exemplary embodiment, the encapsulant layer is an ethylene vinyl acetate.

The method further includes providing a protective layer on the first surface of the encapsulant layer. The protective layer can be disposed on the first surface of the encapsulant layer to form the outer surface of the photovoltaic device. The protective layer can be disposed by any reasonable means such as, for example, by being placed in contact with the encapsulant layer, by lamination, extrusion, coating, and the like. Typically, the method of disposing the protective layer is dependent upon the material used for the protective layer. In an embodiment, the protective layer is a fluoropolymer. The fluoropolymer can be a homopolymer of fluorine-substituted monomers or a copolymer including at least one fluorine-substituted monomer. Exemplary fluoropolymers include polyvinylidene fluoride (PVDF), polyvinyl fluoride (PVF), polytetrafluoroethylene (PTFE), a copolymer of tetrafluoroethylene and perfluoromethylvinylether (PFA or MFA), ethylene tetrafluoroethylene copolymer (ETFE), polychlorotrifluoroethylene (PCTFE), ethylene chlorotrifluoroethylene copolymer (ECTFE), fluorinated ethylene propylene copolymer (FEP), a copolymer of ethylene and fluorinated ethylene propylene (EFEP), a terpolymer of tetrafluoroethylene, hexafluoropropylene, and vinylidene fluoride (THV), a terpolymer of tetrafluoroethylene, hexafluoropropylene, and ethylene (HTE), or any combination thereof. In an embodiment, the fluoropolymer is melt processable. In a particular example, the melt processable fluoropolymer includes ethylene-tetrafluoroethylene copolymer (ETFE), a copolymer of ethylene and fluorinated ethylene propylene (EFEP), fluorinated ethylene propylene copolymer (FEP), polyvinylidene fluoride (PVDF), or combinations thereof. Typically, the ETFE has a melting point of about 260° C. In an embodiment, the fluoropolymer has a melting point less than about 200° C. such as, for example, EFEP, HTE, and THV, depending upon the grade.

The method of texturing the film and making the photovoltaic device further includes mechanically texturing the encapsulant layer and the fluoropolymer layer to form a textured film. In a particular embodiment, mechanical texturing may be provided by any reasonable method that provides a plurality of surface features as described above that form the outer surface and a texture depth that extends into the fluoropolymer layer and the encapsulant layer. For instance, mechanical texturing may be performed by using a textured template with a hot press or a planar laminator, a textured drum, a textured nip roller, a textured fabric, a textured paper, a textured belt, an autoclave, or any combination thereof. In a particular embodiment, the mechanical texturing is performed by using a hot press such as a Carver press. In an embodiment, the mechanical texturing is performed at a temperature and pressure sufficient to provide the plurality of surface features as described above. Further, the mechanical texturing is performed at a temperature and pressure sufficient to adhere the protective layer to the encapsulant layer to form the textured film. When the encapsulant is a thermoplastic, the mechanical texturing may be performed at a temperature sufficient to at least partially deform the thermoplastic encapsulant. In an exemplary embodiment, the mechanical texturing is performed at a temperature sufficient to at least partially, chemically cross-link the polymer used as the encapsulant layer. For instance, when the encapsulant layer is ethylene vinyl acetate, the mechanical texturing includes a hot press at a temperature to at least partially, chemically cross-link the polymer. When the encapsulant layer is ethylene vinyl acetate, the temperature of the hot press is typically at a temperature of at least about 145° C. In an embodiment, the pressure of the hot press is at least about 8 to about 35 lbs per square inch for a time of about 420 seconds. In an embodiment, the textured film is cooled before removing from the platen press. In an embodiment, the textured film is removed while still hot.

In an embodiment, the method of forming the photovoltaic device further includes laminating the mechanically textured film to an active device. Any reasonable active device is envisioned. An exemplary active device converts sunlight into electricity, such as a photovoltaic device. Any reasonable lamination conditions are envisioned. For instance, lamination can be dependent upon the materials that are included in the photovoltaic device. In an embodiment, a typical photovoltaic vacuum laminator is used. In an embodiment, the lamination conditions are chosen to adhere the textured film to the photovoltaic device without substantially degrading the textured film. Degradation may be measured by texture depth retention. “Texture depth retention” as used herein refers to the percentage difference of the texture depth of the surface features post mechanical texturing and then post lamination. Post lamination, at least about 35% of the texture depth is retained. In an embodiment, at least about 40%, at least about 50%, at least about 60%, at least about 70%, at least about 80%, at least about 90%, or even at least about 95% of the texture depth is retained post lamination. In an embodiment, the texture angle of the surface features post lamination is a mean slope of at least about 20°, or even at least about 25°. In an embodiment, the minimum texture depth of the surface features post lamination is at least about 125 μm, such as at least about 250 μm, such as at least about 300 μm, or even at least about 400 μm.

In an embodiment, the second surface of the encapsulant layer is in direct contact with the active device. In another embodiment, an optional layer is sandwiched between the second surface of the encapsulant layer and the active device. Any optional layer may be envisioned such as an adhesive layer, a reinforcing layer, and the like. For instance, an adhesive layer may be disposed between the second surface of the encapsulant layer and the active device. In an embodiment, the adhesive layer is a polyolefin, a copolymer of ethylene and vinyl acetate, vinyl acetate copolymer, acrylate copolymer such as poly(octadecyl acrylate), functionalized polyolefin, polyurethane, polyvinyl butyral, silicone, fluoropolymer, or any combination thereof. An exemplary polymer includes natural or synthetic polymers, including polyethylene (including linear low density polyethylene, low density polyethylene, high density polyethylene, etc.); polypropylene; nylons (polyamides); EPDM; polyesters; polycarbonates; ethylene-propylene copolymers; copolymers of ethylene or propylene with acrylic or methacrylic acids; acrylates; methacrylates; poly alpha olefin melt adhesives such as, for example, ethylene vinyl acetate (EVA), ethylene butyl acrylate (EBA), ethylene methyl acrylate (EMA), ionomers (e.g., acid functionalized polyolefins generally neutralized as a metal salt), or acid functionalized polyolefins; polyurethanes including, for example, thermoplastic polyurethane (TPU); olefin elastomers; olefinic block copolymers; thermoplastic silicones; polyvinyl butyral; a fluoropolymer, such as a terpolymer of tetrafluoroethylene, hexafluoropropylene, and vinylidene fluoride (THV); or any combination thereof.

Further, any additional layers may be provided within the photovoltaic device such as reinforcement layers, protective layers, encapsulant layers, adhesive layers, and the like. In a further embodiment, the laminate stack may further include additional layers such as inorganic barrier layers, barrier layers on polymeric substrates, barrier polymers, transparent conductive oxides (TCO's), and the like. In an embodiment, a reinforcement layer may be provided. Any reasonable material and method may be used to provide the reinforcement layer. In a particular embodiment, the reinforcement layer may be placed between the first encapsulant layer and the active device; however, the reinforcement layer may be disposed in any reasonable position within the photovoltaic device. In an embodiment, the reinforcement layer is a fabric glass mat that may be woven or non-woven. In an embodiment, the fabric glass mat is non-woven. In an embodiment, the fabric glass mat has a fabric weight of about 5 g/m² to about 100 g/m², such as about 10 g/m² to 50 g/m², or even about 20 g/m² to about 30 g/m².

A second encapsulant layer may be provided to sandwich the active device between the first encapsulant layer and the second encapsulant layer. Any reasonable polymer described above as the first encapsulant layer may be used as the second encapsulant layer. Further, a backsheet may also be provided. In an embodiment, the photovoltaic module may be bifacial, i.e. is configured on both sides to receive sunlight and convert the sunlight to electricity.

An alternative method of forming a photovoltaic device is further provided. The method includes providing an active component of the photovoltaic device and providing an encapsulant layer disposed on the active component. Any reasonable method of providing the encapsulant layer is envisioned and is dependent upon the material used as the encapsulant layer. For instance, encapsulant layers may be laminated, extruded, coated, and the like. The encapsulant layer may be any of the materials described above that help protect the photovoltaic device. In a particular embodiment, the encapsulant layer is an ethylene vinyl acetate.

The method further includes disposing a protective layer on the first surface of the encapsulant layer to form the outer surface of the photovoltaic device. The protective layer can be disposed by any reasonable means such as, for example, by being placed in contact with the encapsulant layer, by lamination, extrusion, coating, and the like. Typically, the method of disposing the protective layer is dependent upon the material used for the protective layer. Any protective materials described above may be envisioned. In an embodiment, the protective layer is a fluoropolymer. Any reasonable fluoropolymer as described above is envisioned.

The method further includes laying a fabric on a surface of the protective layer. In an embodiment, the fabric is configured to provide a textured pattern and surface features as described above. Any reasonable fabric may be envisioned. Further, the fabric withstands the heat temperature during lamination without degradation. In an exemplary embodiment, the fabric does not scratch the surface to which it is laid upon. Typically, the fabric has desirable release properties such that it texturizes the fluoropolymer layer by displacing the fluoropolymer with minimal removal of the fluoropolymer. In an embodiment, the fabric is selected so that it is reusable, i.e. can withstand at least two passes through a laminator without loss of texturing function. Further, the fabric is flexible. In an embodiment, the fabric is plied, twisted, or continuous filament fiber yarns. In a particular embodiment, the fabric may be knit, laid, or woven. In an embodiment, the weave is leno weave. In an embodiment, the fabric may be configured with skew ply, twill, twists, loops, wales, and the like. The fabric further may have a weight of about 20 g/m² to about 1110 g/m², such as about 50 g/m² to about 500 g/m², such as about 50 g/m² to about 250 g/m², or about 50 g/m² to about 150 g/m². In an embodiment, the fabric may have a weight of about 200 g/m² to about 700 g/m². The fabric may have a thickness of about 0.5 mm to about 1.5 mm. In an embodiment, the fabric may have about 5 to about 20 yarns per inch in the warp and fill directions. In a particular embodiment, the fabric may be fiberglass.

In an embodiment, any reasonable coating may be used on the fabric. In an embodiment, the coating is a fluoropolymer. Any reasonable amount of coating may be used. In an embodiment, the coating may be from about 0.5 oz/yd² to 40 oz/yd² (about 17 g/m² to about 1350 g/m²). In an embodiment, the weight of the fabric may increase with the addition of a coating. In an embodiment, the weight of the coated fabric is greater than about 50 g/m², such as about 50 g/m² to about 2400 g/m², such as about 300 g/m² to about 1300 g/m². In an embodiment, the thickness of the fabric may increase with the addition of a coating. In an embodiment, the thickness of the coated fabric is greater than about 0.5 mm. Any reasonable method of coating may be used such as dip coating. In an exemplary embodiment, the fabric is coated fabric such as PTFE coated fiberglass.

In an embodiment, the fabric is dimensioned to provide a textured fluoropolymer layer with surface features as described above. In an embodiment, the fabric has a plurality of protrusions, depressions, structures, or openings that press into and displace the fluoropolymer layer to leave an outer surface formed of the textured fluoropolymer. In an embodiment, both the fluoropolymer layer and the encapsulant layer are displaced due to the protrusions, depressions, structures, or openings of the fabric. In an embodiment, the fabric may have a plurality of openings arranged in any reasonable pattern such that once the fabric is removed from the fluoropolymer layer, a textured fluoropolymer layer is disposed on the encapsulant layer. It has been discovered that openings in the fabric also allow for air release or removal during the lamination process. Further, the use of the fabric reduces or eliminates the formation of wrinkles in the solar module, allowing formation of a desired texture with a surface that is free from wrinkles, irregularities, and the like. In particular, the fabric reduces the formation of wrinkles on the fluoropolymer layer and encapsulant layer disposed on the active component after removal of the fabric layer from the fluoropolymer layer.

The method further includes placing the fabric, protective layer, encapsulant layer, and active component in a laminator. The lamination temperature and pressure conditions are sufficient to create a textured surface once the fabric is removed from the fluoropolymer layer as well as adhere the remaining layers together. In an embodiment, a typical photovoltaic vacuum laminator is used. For instance, the lamination conditions are at a temperature of at least about 145° C. After lamination, the fabric is removed from the fluoropolymer layer to provide the textured fluoropolymer layer. In an embodiment, the laminator may include processing aids such as a coated fabric release sheet on the top side of the laminator, the bottom side of the laminator, or combination thereof.

Further, any additional layers may be provided within the photovoltaic device such as reinforcement layers, protective layers, encapsulant layers, adhesive layers, and the like. In a further embodiment, the laminate stack may further include additional layers such as inorganic barrier layers, barrier layers on polymeric substrates, barrier polymers, transparent conductive oxides (TCO's), and the like. In an embodiment, a reinforcement layer may be provided. Any reasonable material and method may be used to provide the reinforcement layer. In a particular embodiment, the reinforcement layer may be placed between the first encapsulant layer and the active device; however, the reinforcement layer may be disposed in any reasonable position within the photovoltaic device. In an embodiment, the reinforcement layer is a fabric glass mat. In an embodiment, the reinforcement serves to constrain flow and thinning of the encapsulant. This can allow maintenance of a sufficient encapsulant thickness to cover and protect all elements of the electronic body being encapsulated. In an embodiment, the reinforcement layer in combination with the encapsulant provides a desirable degree of texturation. In an embodiment, an adhesive layer may be provided and may be disposed in any reasonable position within the photovoltaic device.

A second encapsulant layer may be provided to sandwich the active device between the first encapsulant layer and the second encapsulant layer. Any reasonable polymer described above as the first encapsulant layer may be used as the second encapsulant layer. Further, a backsheet may also be provided. In an embodiment, the photovoltaic module may be bifacial, i.e. is configured on both sides to receive sunlight and convert the sunlight to electricity.

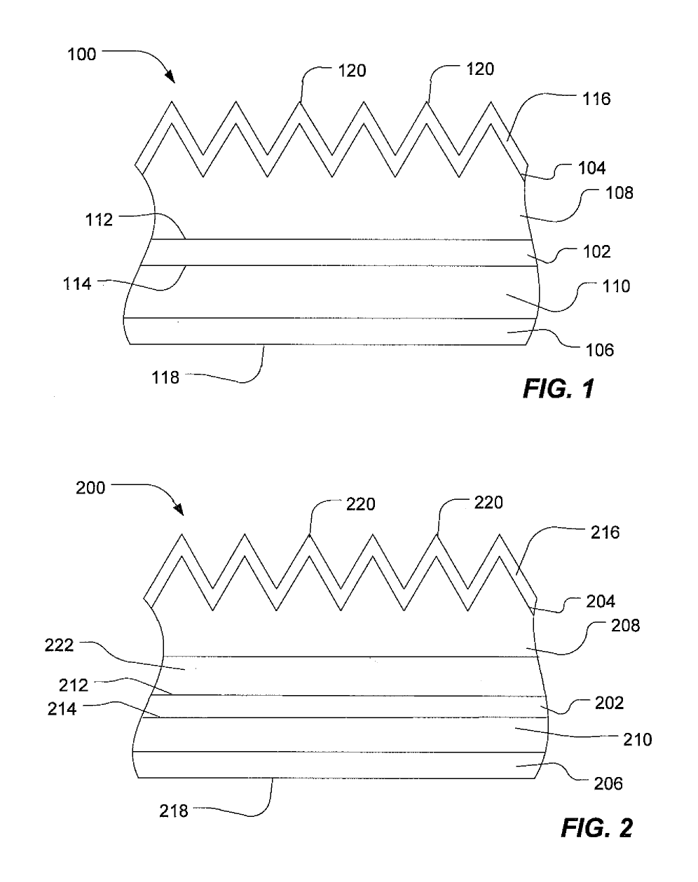

Turning to the figures, FIG. 1 includes an illustration of an exemplary photovoltaic device 100 that includes an active component 102 having a front surface 112 and a back surface 114. In an example, the active component 102 is a single-sided photovoltaic component that receives sunlight on its front surface 112 and converts the sunlight into electricity. In such an embodiment, the back surface 114 can be formed of a support material, supporting the light converting devices. Alternatively, the back surface 114 can also include light converting devices and as such, can convert reflected light or light received at different parts of the day into electricity. The photovoltaic device 100 can be a rigid photovoltaic device or a flexible photovoltaic device. In a particular example, the photovoltaic device 100 is a flexible photovoltaic device.

An encapsulant layer 108 is disposed on the front surface 112 of the active component 102 and a protective layer 104 is disposed on the encapsulant layer 108. The protective layer 104 forms an outer surface 116 of the photovoltaic device 100. Optionally, an encapsulant layer 110 can be disposed on a back surface 114 of the active component 102 and a further protective layer 106 can be formed on the encapsulant layer 110. The protective layer 106 forms a back surface 118 of the photovoltaic device 100. The protective layers 104 or 106 can include surface features 120, which may or may not influence the thickness of the encapsulant layers 108 or 110. The protective layer 104 and 106 can be formed of the same materials or can be formed of different materials. In particular, the protective layers 104 and 106 are formed of materials such as fluoropolymers, as described above.

The encapsulant layers 108 and 110 can be formed of the same materials or can be formed of different materials. In particular, the encapsulant layers 108 and 110 are formed of polymeric materials, as described above. In particular, the encapsulant layers 108 and 110 can be formed of ethylene vinyl acetate.

In a particular example, the polymer layer of the encapsulant layers 108 or 110 can be in direct contact with the protective layer 104 or 106, such as without intervening layers or adhesives. In an alternative example, the encapsulant layers 108 or 110 can include more than one layer. Although not shown, any other reasonable type of layers and number of layers may be included within the photovoltaic module such as reinforcement layers, adhesive layers, protective layers, encapsulant layers, and combinations thereof. In a further embodiment, the laminate stack may further include additional layers such as inorganic barrier layers, barrier layers on polymeric substrates, barrier polymers, transparent conductive oxides (TCO's), and the like. In an embodiment, the photovoltaic device may be crystalline silicon, amorphous silicon, CIGS or similar, CdTe, OPV or DSC.

FIG. 2 includes an illustration of an exemplary photovoltaic device 200 that includes an active component 202 having a front surface 212 and a back surface 214. In an example, the active component 202 is a single-sided photovoltaic component that receives sunlight on its front surface 212 and converts the sunlight into electricity. In such an embodiment, the back surface 214 can be formed of a support material, supporting the light converting devices. Alternatively, the back surface 214 can also include light converting devices and as such, can convert reflected light or light received at different parts of the day into electricity. The photovoltaic device 200 can be a rigid photovoltaic device or a flexible photovoltaic device. In a particular example, the photovoltaic device 200 is a rigid photovoltaic device.

An encapsulant layer 208 is overlies the front surface 212 of the active component 202 and a protective layer 204 is disposed on the encapsulant layer 208. The protective layer 204 forms an outer surface 216 of the photovoltaic device 200. Optionally, an encapsulant layer 210 can be disposed on a back surface 214 of the active component 202 and a glass backsheet 206 can be formed on the encapsulant layer 210. The glass backsheet 206 forms a back surface 218 of the photovoltaic device 200. The protective layer 204 can include surface features 220, which may or may not influence the thickness of the encapsulant layer 208. In particular, the protective layer 204 is formed of materials such as fluoropolymers, as described above.

The encapsulant layers 208 and 210 can be formed of the same materials or can be formed of different materials. In particular, the encapsulant layers 208 and 210 are formed of polymeric materials, as described above. In particular, the encapsulant layers 208 and 210 can be formed of ethylene vinyl acetate.

As seen in FIG. 2, the encapsulant layer 208 or 210 can be in direct contact with the protective layer 204 or 206, respectively, such as without intervening layers or adhesives. In an alternative example, the encapsulant layer 208 or 210 can include more than one layer. In an embodiment, the encapsulant layer 208 directly contacts a third layer 222. In an embodiment, the third layer 222 may be any reasonable layer such as a reinforcement layer, an adhesive layer, or combination thereof. In an embodiment, the third layer 222 is an adhesive layer, such as the ethyl vinyl acetate adhesive as described above. When the adhesive layer is present, the adhesive layer has a thickness of about 12 μm to about 150 μm. In an embodiment, the third layer 222 is a reinforcement layer, such as a fabric glass mat as described above. When the reinforcement layer is present, the reinforcement layer has a thickness of about 75 μm to about 150 μm.

The polymer layers illustrated in FIG. 1 or FIG. 2 can include other additives such as fillers, ultraviolet absorbers, antioxidants and free radical scavengers, desiccants or getters, processing aids, or any combination thereof. In a further embodiment, the laminate stack may further include additional layers such as inorganic barrier layers, barrier layers on polymeric substrates, barrier polymers, transparent conductive oxides (TCO's), and the like. In an embodiment the photovoltaic device may be crystalline silicon, amorphous silicon, CIGS or similar, CdTe, OPV or DSC.

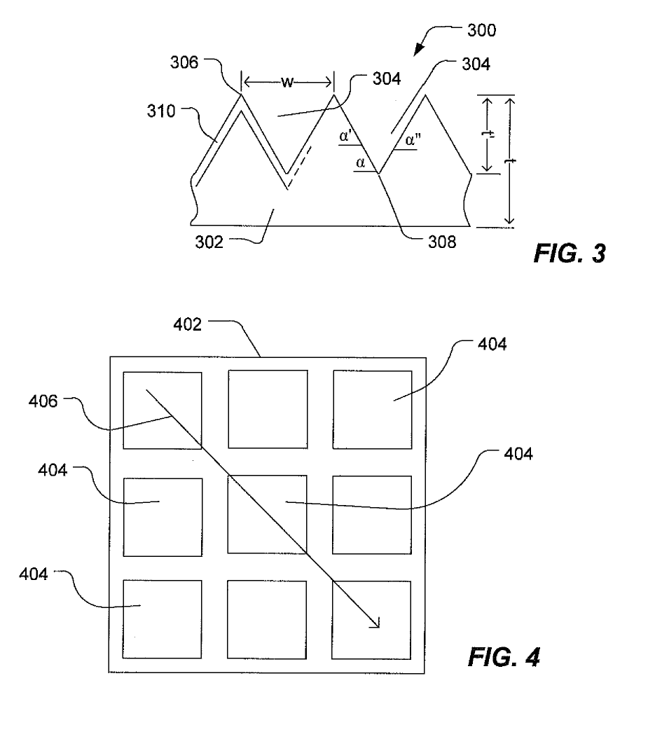

The textured film, including the protective layer and the encapsulant layer, includes a plurality of surface features. For example, the plurality of surface features can be negative surface features defined by the outer protective layer and formed through displacement of portions of the encapsulant layer so that the encapsulant layer has varying thickness. For example, FIG. 3 includes an illustration of an exemplary textured film 300. The textured film 300 includes encapsulant layer 302 and protective layer 310. A plurality of surface features 304, illustrated as negative surface features, is formed into the textured film, forming peaks 306 and valleys 308. Alternatively, the surface features can be positive surface features extending from the surface as protruding features.

The textured film 300 can have a maximum thickness (t) in a range of about 20 μm to about 2000 μm, such as a range of about 50 μm to about 1000 μm, a range of about 150 μm to about 1000 μm, a range of about 200 μm to about 1000 μm, or even a range of about 400 μm to about 700 μm. The protective layer 310 can have a desirable thickness. For example, the protective layer 310 can have an average thickness in a range of about 12 μm to about 150 μm, such as a range of about 12 μm to about 75 μm, or a range of about 20 μm to about 50 μm. The encapsulant layer 302 can have a desirable maximum thickness. For example, the maximum thickness of the encapsulant layer 302 can be in a range of about 20 μm to about 1500 μm, such as a range of about 50 μm to about 1000 μm, a range of about 150 μm to about 1000 μm, a range of about 200 μm to about 1000 μm, or even a range of about 400 μm to about 700 μm. In an embodiment, the encapsulant layer 302 has a thickness of at least about 400 μm.

In an embodiment, the plurality of surface features has a desirable texture ratio. The texture ratio is a ratio of the depth (t′) of the valleys 308 of the surface feature 304 measured from the peak of the surface feature 306, to the depth of the features of the fabric. The features within the fabric are understood to be the geometry of the interlacing and voids of the structure as determined by the weave, knit or laid fabric construction accessible to the film being textured. In an embodiment, the film being textured deforms to the shape defined by this geometry. The texture ratio can be calculated for example for pyramidal structures as illustrated in FIG. 4. When viewed from the top view, the textured film 402 can have a variety of pyramidal surface features 404 extending into the textured film. The depth can be calculated as the average relative height of the peaks along a path 406 that extends through the highest points and the lowest points. In an example, the method of forming the textured film and photovoltaic device it is disposed thereon provides a texture ratio of at least about 0.4, such as at least about 0.45, at least about 0.5, at least about 0.55, at least about 0.60, or even at least about 0.65. In a particular embodiment, as the texture ratio increases, the mean slope increases. Accordingly, methods that provide desired texture ratios tend to result in the desirable mean slope values in the resulting photovoltaic device. The texture ratio is the ratio of the texture depth within the sample divided by the texture depth within the fabric or embossing plate. The texture depth of the sample is determined by extracting a line profile from the height map and averaging the peak to valley heights of the features along the line. The line extends through the maxima and minima of the surface features.

The photovoltaic device including the textured film has desirably improved conversion efficiency. For example, the overall efficiency for converting light to electricity when averaged over incident angles 0° to 90° increases by at least about 0.3% relative to a film of similar construction and average thickness absent the surface features. The incident angle is the angle of light impinging the surface measured relative to the normal to the surface of the active component, i.e., 0° is normal to the surface of the active component. In particular, the improvement in overall efficiency is at least about 0.6%, such as at least about 0.9%, at least about 1.1%, at least about 1.4%, at least about 1.7%, at least about 2.0%, at least about 2.8%, at least about 3.2%, at least about 3.6% or even at least about 4.0%. The improvement is even greater at incident angles greater than about 50°. For example, the improvement in efficiency relative to a film free of surface structures when measured at an incident angle of about 60° is at least about 2.5%, such as at least about 2.9%, at least about 3.3%, at least about 4.0%, at least about 5.0%, at least about 6.0%, at least about 7.0%, or even at least about 8.0%.

### EXAMPLES

### Example 1

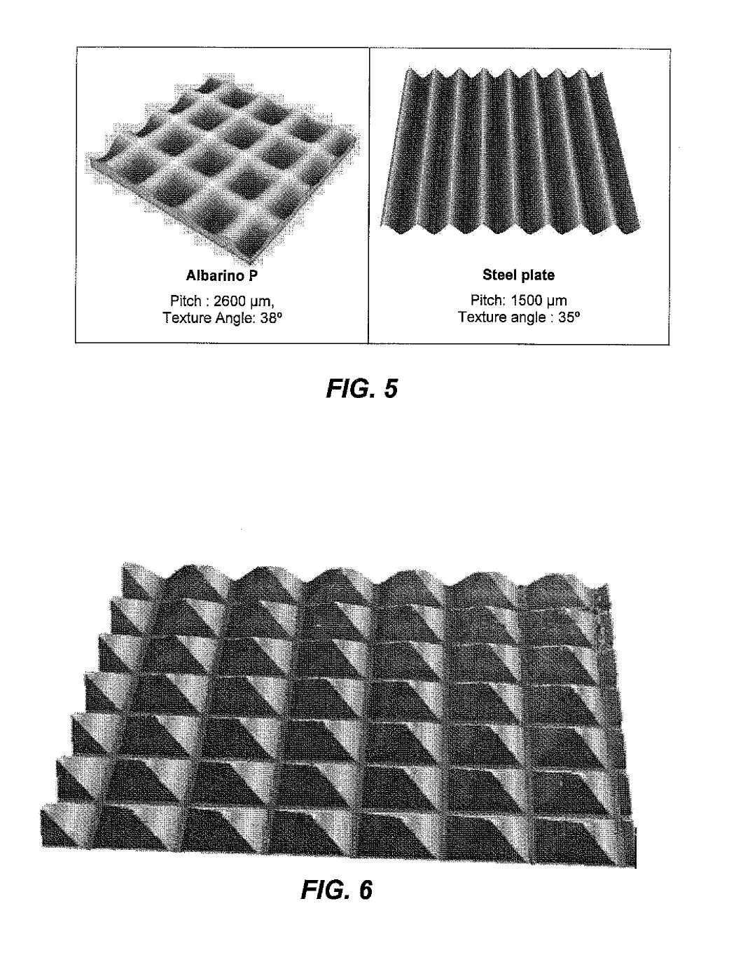

Multiple samples of a textured film are prepared. An exemplary sample is about 1 mil ETFE film disposed on top of about 26 mil EVA. Another exemplary sample is about 1 mil ETFE film disposed on top of about 20 mil Surlyn®. A further exemplary sample is about 1 mil EFEP film disposed on top of about 26 mil EVA. The samples are loaded between two 10″×10″ steel platens and hot pressed in a Carver press. The top steel platen includes a textured steel plate with grooves. The steel plate has a pitch of about 1500 μm and a texture angle of about 35° and can be seen in FIG. 5.

The textured films are then laminated on a photovoltaic device using standard conditions for a photovoltaic vacuum laminator. The textured ETFE and EVA film or the textured EFEP and EVA film are disposed over an adhesive layer of ethylene vinyl acetate having a thickness of about 26 mil, the adhesive layer directly contacting an active cell, such as a Si-cell. The textured ETFE and Surlyn® film are disposed to directly contact an active cell, such as a Si-cell. Texture depth results can be seen in Table 1.

TABLE 1

| | | Texture Depth | Texture Depth | % Texture |
|---|---|---|---|---|
| Sample | Process | and angle post | and angle post | Depth |
| Structure | Conditions | Carver press | lamination | retention |
| ETFE + | Temp = 145° C. | Depth = 339 μm | Depth = 128 μm | 37% |
| EVA | Force = 800-1000 lbs | Mean slope = | Mean slope = | |
| | Time = 420 s | 26.5° | 9.68° | |
| | Sample taken out | | | |
| | hot | | | |
| ETFE + | Temp = 145° C. | Depth = 455 μm | Depth = 275 μm | 60% |
| EVA | Force = 3500 lbs | Mean slope = | Mean slope = | |
| | Time = 420 s | 32° | 23.3° | |
| | Sample cooled | | | |
| ETFE + | Temp = 200° C. | Depth = 395 μm | Depth = 250 μm | 63% |
| Surlyn ® | Force = 2400 lbs | Mean slope = | Mean slope = | |
| | Time = 420 s | 27° | 16.5° | |
| | Sample cooled | | | |
| | down to 60° C. at | | | |
| | constant pressure | | | |
| EFEP + | Temp = 145° C. | Depth = 434 μm | Depth = 408 μm | 94% |
| EVA | Force = 2500 lbs | Mean slope = | Mean slope = 29° | |
| | Time = 420 s | 31° | | |
| | Sample taken out | | | |
| | hot | | | |

It is seen that after the Carver press step and photovoltaic lamination step, a high texture retention ratio is obtained. After lamination, the surface features maintain a minimum depth of at least about 125 μm.

### Example 2

Multiple samples of a textured film are prepared. An exemplary sample is about 1 mil ETFE film disposed on top of about 26 mil EVA. Another exemplary sample is about 1 mil EFEP film disposed on top of about 26 mil of EVA. The samples are textured with a planar laminator with an embossing template of an Albarino P glass template with pyramidal patterns, a negative Albarino glass template with pyramidal patterns, or a steel plate with grooves. The textured templates can be seen in FIGS. 5 and 6. The Albarino P glass template has a pitch of about 2600 μm and a texture angle of about 38°. The cross-sectional width of the pyramidal patterns is about 1.5 mm. The Negative Albarino glass template has a pitch of about 1500 μm and a texture angle of about 45°. The cross-sectional width of the pyramidal patterns is about 1.5 mm. The steel plate has a pitch of about 1500 μm and a texture angle of about 35°. The planar laminator uses standard lamination conditions.

The textured films are then laminated on a photovoltaic device using standard conditions for a photovoltaic vacuum laminator. The textured films are disposed over an adhesive layer of ethylene vinyl acetate at a thickness of about 26 mil, the adhesive layer directly contacting an active cell, such as a Si-cell. Texture depth results can be seen in Table 2.

TABLE 2

| | | | Texture | |
|---|---|---|---|---|
| | | Texture Depth | Depth and | % Texture |
| | Sample | and angle post 1^{st} | angle post Final | Depth |
| Template | Structure | Lamination | Lamination | retention |
| Steel 5 | ETFE + | Depth = 258 μm | Depth = 150 μm | 58% |
| | EVA | Mean slope = | Mean slope = 11° | |
| | | 19° | | |
| Albarino P | ETFE + | Depth = 488 μm | Depth = | 57% |
| | EVA | Mean slope = | 278.5 μm | |
| | | Mean slope = | | |
| | | 20.5° | 11.5° | |
| Negative | EFEP + | Depth = 390 μm | Depth = 365 μm | 94% |
| Albarino | EVA | Mean slope = | Mean slope = 26° | |
| | | 27.5° | | |
| Steel 5 | EFEP + | Depth = 415 μm | Depth = 339 μm | 82% |
| | EVA | Mean slope = | Mean slope = 25° | |
| | | 29° | | |
| Steel 5 | EFEP + | Depth = 360 μm | Depth = 325 μm | 90% |
| | EVA | Mean slope = | Mean slope = 24° | |
| | | 26° | | |

It is seen that after the planar laminator and photovoltaic lamination step, a high texture retention ratio is obtained. After lamination, the surface features maintain a minimum depth of at least about 125 μm.

### Example 3

A solar module stack from top to bottom is provided. The configuration of the solar module stack can be seen in Table 3.

TABLE 3

| Layer | Thickness |
|---|---|
| ETFE frontsheet (top) | about 50 μm |
| EVA encapsulant | about 900 μm |
| Fabric glass mat | about 125 μm |
| Solar Cell | about 150 μm to about 250 μm |
| EVA encapsulant | about 450 μm |
| Glass backsheet (bottom) | about 3.2 mm to about 4.0 mm tempered |
| | or semi-tempered |

A coated fabric with a desired pattern is placed on the ETFE frontsheet. In an embodiment, the fabric is CF1590 fiberglass coated with PTFE available from Saint-Gobain Performance Plastics. In another embodiment, the fabric is CF9014 fiberglass available from Saint-Gobain Performance Plastics. This is an open mesh PTFE coated glass.

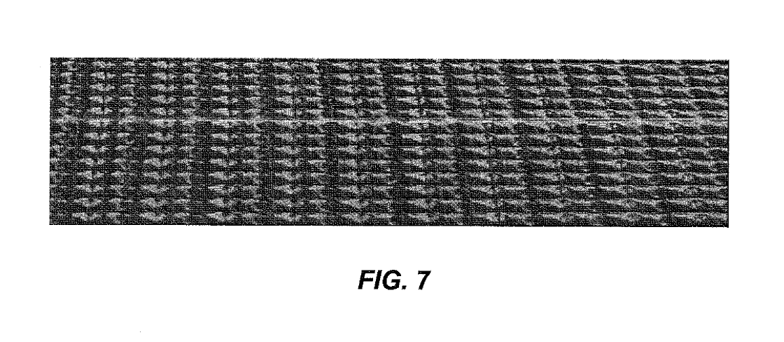

The solar module stack is inserted into a solar module laminator with a platen temperature of about 146° C., a pump time of about 240 seconds, and a press time of about 600 seconds. The lamination adheres the solar module layers. After lamination, the coated fabric mesh is removed from the fluoropolymer layer, leaving a textured fluoropolymer layer. The texture made on a module with the PTFE coated CF 1590 material can be seen in FIG. 7.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A method of forming a photovoltaic device comprises:
providing an active component;
providing an encapsulant layer disposed on the active component;
providing a fluoropolymer layer on the encapsulant layer;
laying a fabric on a surface of the fluoropolymer layer, wherein the fabric has a plurality of openings configured to provide a textured pattern on the fluoropolymer layer;
laminating the active component, encapsulant layer, fluoropolymer layer, and fabric; and
removing the fabric from the fluoropolymer layer to provide a textured fluoropolymer layer disposed on the encapsulant layer, the textured fluoropolymer layer having a plurality of surface features that form an outer surface.

2. The method of claim 1, wherein the fabric is configured to form a plurality of three dimensional surface features.

3-4. (canceled)

5. The method of claim 1, wherein the fabric is a fluoropolymer coated fiberglass.

6-10. (canceled)

11. The method of claim 1, wherein the mean slope of the surface features is at least about 20°.

12. (canceled)

13. The method of claim 1, wherein the encapsulant layer is a chemically crosslinkable polymer.

14. (canceled)

15. The method of claim 1, wherein the fluoropolymer is selected from the group consisting of polytetrafluoroethylene (PTFE), perfluoroalkylvinyl ether (PFA or MFA), fluorinated ethylene-propylene copolymer (FEP), ethylene tetrafluoroethylenecopolymer (ETFE), polyvinylidene fluoride (PVDF), polychlorotrifluoroethylene (PCTFE), TFE copolymers with VF2 or HFP, ethylene chlorotrifluoroethylene copolymer (ECTFE), a copolymer of ethylene and fluorinated ethylene propylene (EFEP), a terpolymer of tetrafluoroethylene, hexafluoropropylene, and vinylidene fluoride (THV), a terpolymer of tetrafluoroethylene, hexafluoropropylene, and ethylene (HTE), and a combination thereof.

16-20. (canceled)

21. The method of claim 1, further comprising disposing a reinforcement layer between the encapsulant layer and the active component.

22. (canceled)

23. The method of claim 1, wherein the active component is a flexible photovoltaic device or a rigid photovoltaic device.

24. The method of claim 1, wherein the fabric reduces the formation of wrinkles on the fluoropolymer layer and encapsulant layer disposed on the active component after removal of the fabric layer from the fluoropolymer layer.

25. A textured film comprises:
a first layer forming an outer surface and comprising a fluoropolymer; and
a second layer comprising an encapsulant; wherein the first layer and the second layer are mechanically textured to provide a plurality of surface features on the outer surface and extend into the second layer.

26. The textured film of claim 25, wherein the plurality of surface features are pyramidal, circular, spherical, square, rectangular, polyhedral, triangular, truncated triangular, tetrahedral, or combinations thereof.

27. (canceled)

28. The textured film of claim 25, wherein the encapsulant is a chemically, cross-linkable polymer.

29. (canceled)

30. The textured film of claim 25, wherein the encapsulant is a thermoplastic polymer.

31. The textured film of claim 25, wherein the fluoropolymer is selected from the group consisting of polytetrafluoroethylene (PTFE), perfluoroalkylvinyl ether (PFA or MFA), fluorinated ethylene-propylene copolymer (FEP), ethylene tetrafluoroethylene copolymer (ETFE), polyvinylidene fluoride (PVDF), polychlorotrifluoroethylene (PCTFE), TFE copolymers with VF2 or HFP, ethylene chlorotrifluoroethylene copolymer (ECTFE), a copolymer of ethylene and fluorinated ethylene propylene (EFEP), a terpolymer of tetrafluoroethylene, hexafluoropropylene, and vinylidene fluoride (THV), a terpolymer of tetrafluoroethylene, hexafluoropropylene, and ethylene (HTE), and a combination thereof.

32-34. (canceled)

35. The textured film of claim 25, wherein the mean slope of the surface features is at least about 20°.

36-38. (canceled)

39. The textured film of claim 25, wherein the second layer overlies an active component of a photovoltaic device.

40. The textured film of claim 39, further comprising a reinforcement layer disposed between the second layer and the active component.

41. (canceled)

42. The textured film of claim 39, further comprising an adhesive layer disposed between the second layer and the active component.

43. (canceled)

44. A method of forming a photovoltaic module comprises:
providing an encapsulant layer having a first surface and a second surface;
providing a fluoropolymer layer disposed on the first surface;
mechanically texturing the encapsulant layer and the fluoropolymer layer to provide a plurality of surface features that form an outer surface and a texture depth extending into the fluoropolymer layer and the encapsulant layer; and
laminating the mechanically textured encapsulant layer and fluoropolymer layer to an active device, wherein the texture angle of the surface features post lamination is a mean slope of at least about 20°.

45. The method of claim 44, wherein a minimum depth of about 125 μm of the surface feature is retained post lamination.

46. The method of claim 44, wherein the plurality of surface features are pyramidal, circular, spherical, square, rectangular, polyhedral, triangular, truncated triangular, tetrahedral, or combination thereof.

47. (canceled)

48. The method of claim 44, wherein the mechanical texturing is provided by a hot press or planar laminator.

49. The method of claim 44, wherein the mechanical texturing is at a temperature sufficient to at least partially chemically cross-link the encapsulant layer.

50. The method of claim 44, wherein the mechanical texturing is at a temperature sufficient to at least partially deform a thermoplastic encapsulant.

51-52. (canceled)

53. The method of claim 44, wherein the fluoropolymer is selected from the group consisting of polytetrafluoroethylene (PTFE), perfluoroalkylvinyl ether (PFA or MFA), fluorinated ethylene-propylene copolymer (FEP), ethylene tetrafluoroethylene copolymer (ETFE), polyvinylidene fluoride (PVDF), polychlorotrifluoroethylene (PCTFE), TFE copolymers with VF2 or HFP, ethylene chlorotrifluoroethylene copolymer (ECTFE), a copolymer of ethylene and fluorinated ethylene propylene (EFEP), a terpolymer of tetrafluoroethylene, hexafluoropropylene, and vinylidene fluoride (THV), a terpolymer of tetrafluoroethylene, hexafluoropropylene, and ethylene (HTE), and a combination thereof.

54-58. (canceled)

59. The method of claim 44, wherein the active device is a flexible photovoltaic device or a rigid photovoltaic device.
